(19) United States
(12) Patent Application Publication
(10) Pub. No.: US 2025/0217837 A1
(43) Pub. Date: Jul. 3, 2025

(54) SYSTEM AND METHOD FOR REWARD GENERATION ON SOCIAL MEDIA PLATFORM

(71) Applicant: RAVNEET SINGH, CORAL SPRINGS, FL (US)

(72) Inventor: RAVNEET SINGH, CORAL SPRINGS, FL (US)

(21) Appl. No.: 18/399,825

(22) Filed: Dec. 29, 2023

(51) Int. Cl. G06Q 30/0207; G06Q 20/10; G06Q 50/00; H04L 9/00; H04L 67/306

(52) U.S. Cl. CPC G06Q 30/0224; G06Q 20/10; G06Q 50/01; H04L 9/50; H04L 67/306

(57) ABSTRACT

A system for reward generation on a social media platform is disclosed. The system includes a processing subsystem having a registration module linking multiple social media accounts for a user. An engagement calculation module identifies key metrics like likes, comments, and shares, calculating individual metrics for each engagement type. The engagement calculation module computes a total engagement value for specific posts or overall accounts. The training module uses historical data to train machine learning models, fine-tuning hyperparameters for iterative improvement. The reward generation module establishes a conversion rate between total engagement and reward points, dynamically assigning loyalty through trained models. A reward redemption module facilitates the accumulation of points in a virtual wallet, converting them into various assets like money or cryptocurrency using blockchain integration. This comprehensive approach ensures a fair and personalized reward system based on user engagement levels.

### FIELD OF INVENTION

Embodiments of the present disclosure relate to analysis from social networks, and more particularly to, a system and a method for reward generation on social media platform.

### BACKGROUND

The concept of reward generation on social media-based platforms involves incentivizing users for their engagement and contributions. On these platforms, users can earn rewards, often in the form of points, badges, or other virtual currencies, by actively participating in various activities such as liking, sharing, commenting, or creating content. These rewards aim to encourage user engagement, foster a sense of community, and acknowledge valuable contributions. To effectively implement reward generation on social media platforms, it's essential to strike a balance between encouraging engagement and ensuring the authenticity and value of user interactions. However, to effectively implement reward generation on social media platforms, it's essential to strike a balance between encouraging engagement and ensuring the authenticity and value of user interactions.

Many existing systems offer limited or uninspiring options for redeeming rewards. Users may lose interest if the rewards are not appealing or if there's a lack of variety in the redemption choices. In some cases, reward systems are controlled by a single entity, leading to potential bias or lack of transparency. Users may be sceptical about the fairness of the reward distribution process. Rewards, such as virtual badges or points, may lack tangible real-world value. Users may lose interest if they do not see practical benefits or if the rewards do not align with their interests and preferences. Furthermore, some users may be hesitant to actively participate in reward systems if they have concerns about the platform's data privacy practices. Clear communication and transparency are crucial to address these concerns.

Hence, there is a need for an improved system and method for reward generation on social media platform to address the aforementioned issues.

### BRIEF DESCRIPTION

In accordance with an embodiment of the present disclosure, system for reward generation on social media platform is disclosed. The system includes a hardware processor. The system also includes a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules. The processing subsystem includes a registration module configured to register a user using one or more credentials to link corresponding plurality of social media accounts. The processing subsystem also includes an engagement calculation module operatively coupled to the registration module, wherein the engagement calculation module is configured to identify a plurality of key engagement metrics comprising likes, comments, shares, clicks, follows, mentions, and impressions for registered user on the corresponding plurality of social media accounts. The engagement calculation module is also configured to calculate a plurality of individual engagement metrics corresponding to each type of engagement. The engagement calculation module is further configured to calculate a total engagement value by summing up the plurality of individual engagement metrics to calculate for a specific post, content piece, or overall account. The processing subsystem further includes a training module operatively coupled to the engagement calculation module, wherein the training module is configured to obtain historical dataset comprising user interactions, engagement metrics, from the social media platform. The training module is also configured to train one or more machine learning models on historical dataset using a defined state representation, an action space, and a reward function. The training module is further configured to fine-tune hyperparameters and optimize the reward function comprising adjusting the one or more machine learning models, learning rates, and discount factors to iterate on the training process. The processing subsystem further includes a reward generation module operatively coupled to the training module, wherein the reward generation module is configured to set a conversion rate between the total engagement value and reward points. The reward generation module is also configured to calculate the reward points for each user or post based on determined conversion rate. The reward generation module is further configured to dynamically assign loyalty in the reward points to the user based on the engagement level using one or more trained machine learning models. The processing subsystem further includes a reward redemption module operatively coupled to the reward generation module, wherein the reward redemption module is configured to create a virtual wallet for the users to accumulate the reward points. The reward redemption module is also configured to convert accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms.

In accordance with another embodiment of the present disclosure, a method for reward generation on social media platform. The method includes registering, by a registration module, a user using one or more credentials to link corresponding plurality of social media accounts. The method also includes identifying, by an engagement calculation module, a plurality of key engagement metrics comprising likes, comments, shares, clicks, follows, mentions, and impressions for registered user on the corresponding plurality of social media accounts. The method further includes calculating, by the engagement calculation module, a plurality of individual engagement metrics corresponding to each type of engagement. The method further includes calculating, by the engagement calculation module, a total engagement value by summing up the plurality of individual engagement metrics to calculate for a specific post, content piece, or overall account. The method further includes obtaining, by a training module, historical dataset comprising user interactions, engagement metrics, from the social media platform. The method further includes training, by the training module, one or more machine learning models on historical dataset using a defined state representation, an action space, and a reward function. The method further includes fine-tuning, by the training module, hyperparameters and optimize the reward function comprising adjusting the one or more machine learning models, learning rates, and discount factors to iterate on the training process. The method further includes setting, by a reward generation module, a conversion rate between the total engagement value and reward points. The method further includes calculating, by the reward generation module, the reward points for each user or post based on determined conversion rate. The method further includes dynamically assigning, by the reward generation module, loyalty in the reward points to the user based on the engagement level using one or more trained machine learning models. The method further includes creating, by a reward redemption module, a virtual wallet for the users to accumulate the reward points. The method further includes converting, by the reward redemption module, accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for reward generation on social media platform in accordance with an embodiment of the present disclosure;

FIG. 2 is a block diagram of an embodiment of a system for reward generation on social media platform in accordance with an embodiment of the present disclosure;

FIG. 3 is a schematic representation of an exemplary embodiment of a system for reward generation on social media platform of FIG. 1 in accordance with an embodiment of the present disclosure;

FIG. 4 is a block diagram of a computer or a server in accordance with an embodiment of the present disclosure;

FIG. 5(a) is a flow chart representing the steps involved in a method for reward generation on social media platform of FIG. 1 in accordance with an embodiment of the present disclosure; and

FIG. 5(b) is a flow chart representing the continued steps of method of FIG. 5(a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system for reward generation on a social media platform. As used herein, “social media platform refers to an online digital service or website that enables users to create, share, and interact with content and connect with other users”. The main solutions disclosed herein relate to a new approach within social media applications or entities. As used herein, the term “application” (or “app”) refers generally and without limitation to a unit of executable software that implements a certain functionality or theme, including as found in a social media environment. The themes of applications vary broadly across any number of disciplines and functions (such as on-demand content management, e-commerce transactions, posts, blockchain transactions, etc.), and an application may have more than one theme. The unit of executable software generally runs in a predetermined environment. For example, a processor apparatus may obtain and execute instructions from a non-transitory computer-readable storage medium where the instructions are compiled for the processor on a network receiving and sending data from a social media platform. The system provides a streamlined and consistent approach to the blockchain environment surrounding social media platforms. As used herein “the blockchain environment includes a blockchain platform which is a shared digital ledger that allows users to record transactions and share information securely, tamper resistant.

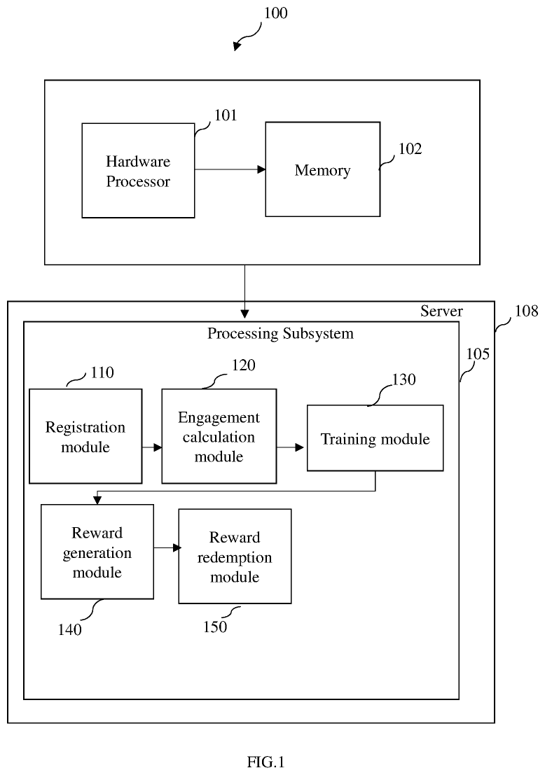

FIG. 1 is a block diagram of a system 100 for reward generation on a social media platform in accordance with an embodiment of the present disclosure. The system 100 includes a hardware processor 101 and a memory 102 coupled to the hardware processor 101. The memory 102 includes a set of program instructions in the form of a processing subsystem 105 and configured to be executed by the hardware processor 101. As used herein, the hardware processor performs data processing, decision making, and all general computing tasks and coordinates tasks done by memory, disk storage, and other system components. The processing subsystem 105 is hosted on a sever 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a registration module 110 configured to register a user using one or more credentials to link corresponding plurality of social media accounts. In one embodiment, the one or more credentials may include email and phone number. In some embodiments, the registration module 110 is configured to receive current location from the user to set a user profile. The current location may be provided through global positioning system (GPS). In a specific embodiment, the registration module 110 is configured to generate verification mark on the user profile upon setting the user profile. For example, meeting the eligibility criteria and maintaining a positive and authentic online presence significantly increases the likelihood of successfully obtaining a verification mark. In a preferred embodiment, the registration module 110 is configured to receive selection of a request list from the user, wherein the request list comprises pay me followers, reward me followers or favor me followers. Specifically, the registration module provides “Favor me”, “Reward me” and “pay me” feature, wherein favour me is the ability to do a favor on social media and record the transaction between one or multiple social media account users. Similarly, reward me is the ability to gift by ecommerce or product the influencer for doing something for you. Also, pay me is the ability to receive fiat or crypto for doing a transaction of a social media post. In one embodiment, the registration module 110 is configured to enable the user to initiate live chat, drop and feed to create post on the corresponding plurality of social media accounts. In a specific embodiment, the user may include a follower, an influencer or a brand.

Also, the processing subsystem 105 includes an engagement calculation module 120 operatively coupled to the registration module 110. The engagement calculation module 120 is configured to identify a plurality of key engagement metrics comprising likes, comments, shares, clicks, follows, mentions, and impressions for registered user on the corresponding plurality of social media accounts. More specifically, the users earn rewards based on their level of engagement with the platform, including interactions with posts, sharing content, or participating in discussions. The social media platforms may reward users for creating high-quality content, such as posts, videos, or images, that receive positive feedback or high levels of engagement. Influencers or users with a significant following may receive special rewards or perks for their impact on the platform, encouraging them to continue generating valuable content.

The engagement calculation module 120 is also configured to calculate a plurality of individual engagement metrics corresponding to each type of engagement. The engagement calculation module 120 is further configured to calculate a total engagement value by summing up the plurality of individual engagement metrics to calculate for a specific post, content piece, or overall account. For each type of engagement, calculate the respective metric. For example:
Likes: Count the number of likes on a post.
Comments: Count the number of comments made on a post.
Shares: Count the number of times a post is shared.
Clicks: Measure the number of clicks on links or multimedia content.
Follows: Count the number of new followers gained.

The defined state representation comprises features and variables of current state of the social media platform, wherein the current state may include user activity, post content, time of day and contextual information. The action space may include promoting specific content, suggesting friend connections or recommending engagement strategies. Particularly, Sum up the individual engagement metrics to calculate the total engagement for a specific post, content piece, or overall account. The formula for total engagement might look like:

Total Engagement=Likes+Comments+Shares+Clicks+Follows+ . . .

In one embodiment, the engagement calculation module 120 is configured to compare engagement across different posts or the plurality of social media accounts for normalizing the plurality of key engagement metrics, wherein normalizing the plurality of key engagement metrics may include calculating an engagement rate as a percentage of total audience or reach.

$$Engagement Rate = ( Total Followers or Reach / Total Engagement ) \times 100$$

In another embodiment, the engagement calculation module 120 is configured to determine average engagement metrics over a predefined period to identify trends and patterns in engagement.

$$Average Engagement = Number of Posts or Content Pieces / Sum of Total Engagements$$

In some embodiments, the engagement calculation module 120 is configured to track engagement metrics over time to observe trends, spikes, or dips. The engagement calculation module 120 is also configured to analyse the correlation with content types, posting times, and external factors. The engagement calculation module 120 is configured to segment engagement data based on varied factors like content type, audience demographics, or posting frequency. This allows for a more granular understanding of what resonates with specific segments of the audience. Further, the engagement calculation module 120 is configured to compare engagement rates with industry benchmarks or competitors to assess performance and identify areas for improvement. In one embodiment, the influencer, the brand or the fan will get a creative brief which sets the tone for the content. The value of the content is key. It's not just about the number of followers; it's about engagement, impact, and the value it brings to the brand.

Furthermore, the processing subsystem 105 further includes a training module 130 operatively coupled to the engagement calculation module 120. The training module 130 is configured to obtain historical dataset including user interactions, engagement metrics, from the social media platform. The training module 130 is also configured to train one or more machine learning models on historical dataset using a defined state representation, an action space, and a reward function. The training module 130 is further configured to fine-tune hyperparameters and optimize the reward function comprising adjusting the one or more machine learning models, learning rates, and discount factors to iterate on the training process. In one embodiment, the one or more machine learning models may include deep reinforcement learning models comprising deep Q-networks (DQN), policy gradient methods, and actor-critic models. In detail, the one or more machine learning models may include recommendation systems which is utilized to suggest personalized content and rewards based on user preferences, engagement history, and demographic information, collaborative filtering which recommends rewards based on the preferences and behaviors of similar users, enhancing the personalization of the reward system, Natural Language Processing (NLP) which includes sentiment analysis that analyzes user comments and feedback to determine the sentiment and emotional tone, enabling more accurate reward assignment based on positive or negative interactions, Topic Modelling which identifies the main topics and themes in user-generated content, allowing for targeted rewards related to trending or relevant subjects. In another embodiment, the training module utilizes one or more deep learning models comprising Neural Networks which is applied for complex pattern recognition, enabling the system to learn and adapt to changing user behaviors and engagement patterns over time, Deep Reinforcement Learning which is used to optimize reward assignment by learning from past interactions and adjusting the reward strategy for better engagement outcomes. In another embodiment, the training module utilizes one or more Graph Theory Algorithms which includes centrality algorithms that identify influential users within a social network, allowing for strategic reward allocation to users with higher social influence, Community Detection Algorithms that group users into communities based on common interests or interactions, facilitating targeted rewards within specific user clusters. In yet another embodiment, the processing subsystem may include one or more Blockchain Algorithms including consensus algorithms that ensure the secure and transparent recording of transactions and reward assignments on the blockchain, enhancing trust and accountability in the reward system, Smart Contracts that self-executing contracts that automatically trigger reward distribution based on predefined conditions, providing a decentralized and tamper-resistant reward mechanism.

Furthermore, in one embodiment, the training module 130 is configured to simulate the one or more trained machine learning models in a controlled environment to evaluate performance, wherein the performance includes understanding of how the one or more trained machine learning model's actions impact user engagement and other metrics. In such an embodiment, the training module 130 may be configured to implement mechanisms for continuous learning and adaptation. As the social media platform evolves and user behaviors change, the deep reinforcement learning model should adapt to new patterns and trends. Further, the training module 130 establishes a monitoring system to continuously track the impact of the reward generation system on user engagement and implements a feedback loop to incorporate user feedback and adjust the model accordingly.

Moreover, the processing subsystem 105 further includes a reward generation module 140 operatively coupled to the training module 130. The reward generation module 140 is configured to set a conversion rate between the total engagement value and reward points. The reward generation module 140 is also configured to calculate the reward points for each user or post based on determined conversion rate. The reward generation module 140 is further configured to dynamically assign loyalty in the reward points to the user based on the engagement level using one or more trained machine learning models. In one embodiment, the reward generation module 140 is configured to automatically mint non-fungible tokens (NFTs) for followers of a social media account when a follower follows an influencer, based on a designated follower collection. In such an embodiment, the reward generation module 140 is configured to distribute non-fungible tokens (NFTs) to a wallet of the followers of the social media account wallets upon performing one or more activities comprising following, promoting, engagement and expanding social reach. In some embodiments, values are assigned to influencers for brands. In another embodiment, values are assigned to NFT drops. Because people set the number of NFTs that will be release on drop based on how many they can sell with the goal of selling out. But they still want to reward their most loyal supporters by allowing them to guaranteed mint if they want to, thus, the set a price to attend the drop for non-subscribers may still allow the project to sell out. In one embodiment, the volunteer fans are incentivized with the rewards.

In such embodiment, currency for reward may be distributed through merchant transaction, credit card, ACH, PayPal, Venmo, QR code, lightning network or the like. This is considered as a sponsored ad post. The post could be in the form of a reel, post, video, gif, audio, or any feature on multiple of social media platforms. Each of these features are based on the identifier account that can be found on a web-based page and the bank account and details of them will be queried by the identifiers. On their characteristics, stats, followers total that will be validated by third parties and not directly inputted by them.

Additionally, the processing subsystem 105 further includes a reward redemption module 150 operatively coupled to the reward generation module 140, wherein the reward redemption module 150 is configured to create a virtual wallet for the users to accumulate the reward points. The reward redemption module 150 is also configured to convert accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms. In detail, this involves implementing the digital wallet within the social media platform. A wallet is a secure and personalized space for each user where their earned reward points are stored. This wallet serves as a virtual representation of the user's earnings. Users accumulate reward points based on their engagement activities on the social media platform. Engagement activities include interactions such as likes, comments, shares, clicks, follows, and other meaningful interactions with content or other users. The earned reward points are convertible into different assets, providing users with flexibility in how they choose to utilize their rewards. The conversion is not limited to a single option, and users can select from a range of assets based on their preferences. Users have the option to convert their reward points into real-world currency. This could involve transferring funds to their bank accounts, receiving payments through online payment systems (such as PayPal or Venmo), or any other method that facilitates the conversion of points into monetary value. In addition to traditional currency, users may have the option to convert their reward points into cryptocurrency. This could involve receiving a specific amount of a chosen cryptocurrency directly into their cryptocurrency wallet. Users may choose to convert their reward points into gift cards from various retailers or online platforms. The social media platform may partner with distinct brands to offer a diverse selection of gift cards that cater to users' preferences. The conversion rate or the number of reward points required for each unit of the chosen asset may be influenced by the user's engagement levels. Higher levels of engagement could result in more favorable conversion rates or additional bonuses.

The reward redemption module 150 offers users multiple options for converting their reward points into assets. Common options include money where users may choose to convert their points into real-world currency, which can be transferred to their bank account or an online payment system, cryptocurrency where users may opt to convert their points into a specific cryptocurrency, receiving the equivalent value in their cryptocurrency wallet and gift cards where users can select from a variety of gift cards offered by partner brands and retailers. The platform establishes conversion rates for each option, determining how many reward points are equivalent to a unit of the chosen asset. For example, there may be a set rate for converting 100 reward points into $1, a certain amount of cryptocurrency, or a specific gift card value.

Users initiate the conversion process through the platform's interface. They navigate to the section dedicated to reward points, choose their preferred asset conversion option, and specify the number of points they want to convert. The platform validates the user's request, ensuring that the conversion is within the user's available balance and complies with any platform-specific rules or limits. Security measures are in place to authenticate the user. For options like money or cryptocurrency, the platform integrates with external financial systems or blockchain networks. The conversion request triggers the transfer of funds or cryptocurrency to the user's designated account or wallet. If the user chooses a gift card, the platform issues a digital or physical gift card with the specified value. The user can then use this gift card for purchases at the respective retailer or online platform.

The platform provides users with confirmation of the successful conversion. Users may receive notifications through the platform, email, or other communication channels, confirming the completion of the transaction. The platform maintains a record of users' conversion activities, allowing users to review their transaction history and track how their reward points have been converted over time. In one embodiment, the influencers and content creators often receive compensation, and it comes in various forms, ranging from tangible rewards to non-tangible payments. The most straightforward form of reward redemption is money. Brands may pay influencers a fee for creating and promoting content. Sometimes, instead of cash, influencers might receive physical products or access to services. Unboxing and showcasing these items can add an extra layer of authenticity to the content. Some influencers are rewarded with experiences, like all-expense-paid trips, event invitations, or exclusive access. Sharing these experiences can create compelling and engaging content. In some cases, the influencers may receive branded merchandise or customized products. This not only serves as a reward but also acts as a promotional tool for the brand. The non-tangible payments may include exposure, collaboration opportunities, recognition and networking. For smaller influencers or those starting, exposure is a valuable currency. Being featured by a brand can significantly increase an influencer's reach and follower count. Brands may offer influencers the chance to collaborate on future projects or become brand ambassadors. This could lead to long-term partnerships and increased visibility. Public acknowledgment, shoutouts, or features on a brand's social media channels can be a form of non-tangible payment. Building relationships with brands, industry leaders, or other influencers can be a priceless non-tangible benefit. It opens doors for future opportunities and collaborations.

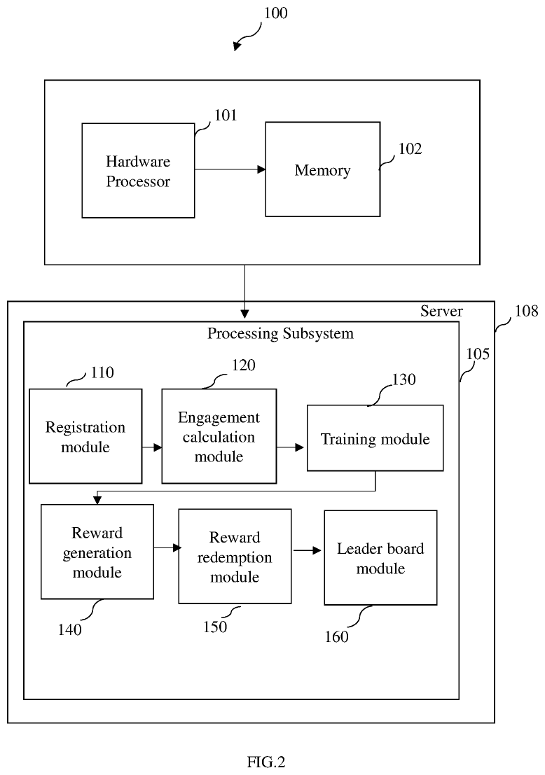

FIG. 2 is a block diagram representation of an embodiment of the system of FIG. 1 in accordance with an embodiment of the present disclosure. The system of FIG. 1 includes a processing subsystem 105 including a registration module 110, an engagement calculation module 120, a training module 130, a reward generation module 140 and a reward redemption module 150. In one embodiment, the processing subsystem 105 may include a leader board module 160 which is configured to display a list of leaders based on ranking of the users based on number of reward points or badges earned. The leader board module 160 is configured to display a leader board based on popularity of users based on ranking engagement with followers. Displaying leaderboards based on users' reward points or achievements can add a competitive aspect, motivating users to increase their participation and climb the ranks. The leaderboard is dynamic and provides real-time updates to reflect the current standings of users. As users continue to engage and earn points, the rankings on the leaderboard adjust accordingly. This real-time aspect adds a sense of immediacy and encourages users to actively participate. The leaderboard module 160 may offer customization options and filters, allowing users to view specific leaderboards based on different criteria. For example, users might explore leaderboards for specific time periods, categories, or types of engagement. In one embodiment, the content creator may receive feedback or response through leader board timely. In some embodiments, the leader board is created based on organization, where the leader board may include a relative leader board or social leader board. The organization is identified on the content using hashtags, mentions, Emoji, URL, keyword, capitalization of words. Motivations can vary widely and include factors such as entertainment, information-seeking, social connection, or participation in discussions. Understanding the motivation behind user engagement helps influencers and brands tailor their content to better resonate with their audience. The rationalization of an influencer involves providing logical or reasonable explanations for the influencer's actions, decisions, or content. The influencers may rationalize their choices to maintain authenticity, align with their personal brand, or address any potential questions or concerns from their audience. In a preferred embodiment, the leader board may be configured to display categorization of fan such as type of fans.

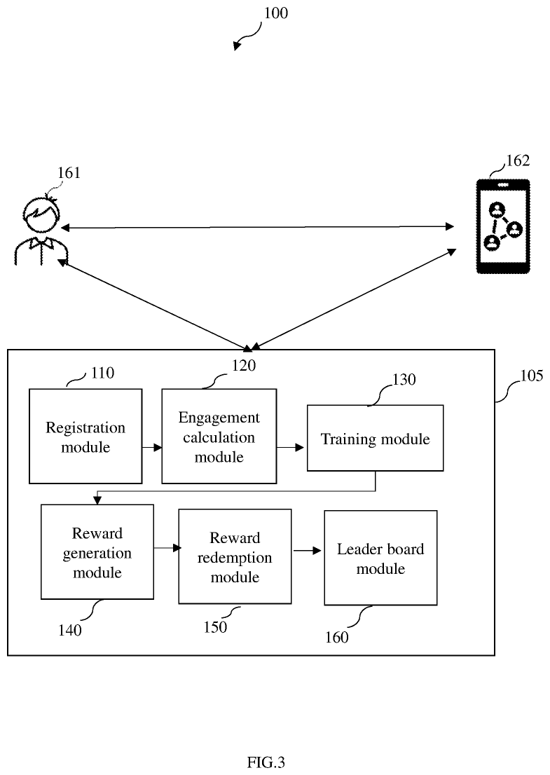

FIG. 3 is a schematic representation of an exemplary embodiment of system 100 of FIG. 1 in accordance with an embodiment of the present disclose. Considering a real time scenario where a user Alex, is a social media influencer 161 who is active across multiple platforms such as Instagram, Twitter, and YouTube. Alex registers on a cutting-edge social media platform 162 that has implemented an advanced reward generation system to recognize and incentivize user engagement. Alex uses the registration module 110 to seamlessly link their Instagram, Twitter, and YouTube accounts to the platform using credentials. The engagement calculation module 120 strikes into action, identifying key metrics such as likes, comments, shares, clicks, follows, mentions, and impressions for every piece of content Alex shares on the connected social media accounts. For each type of engagement, the module calculates individual metrics. For instance, it assesses the number of likes, comments, and shares for each Instagram post, each tweet, and each YouTube video.

By summing up the individual engagement metrics, the module calculates a total engagement value for Alex. This provides a comprehensive overview of Alex's influence and engagement across all social media channels. The training module 130 steps in, using a historical dataset of Alex's interactions and engagement metrics from the platform. Machine learning models are trained with a defined state representation, action space, and reward function. Hyperparameters are fine-tuned to optimize the learning process. The reward generation module 140 sets a conversion rate between the total engagement value and reward points. It dynamically assigns loyalty in reward points to Alex based on engagement levels, leveraging insights from the trained machine learning models. The reward redemption module 150 creates a virtual wallet for Alex within the platform. Alex accumulates reward points in this wallet based on the engagement generated by their social media posts. As Alex accumulates reward points, the reward redemption module allows them to convert these points into assets. Alex can choose from a variety of options, including money, cryptocurrency, or gift cards. The conversion rates are established for each asset, ensuring transparency and fairness.

The platform seamlessly integrates with blockchain-based platforms to secure and authenticate the conversion of reward points into assets. This ensures a tamper-proof and transparent process. Alex, motivated by the opportunity to convert engagement into tangible assets, continues to produce high-quality content. The leaderboard module 160 recognizes Alex's achievements, providing additional incentives, rewards, or badges for consistently ranking high on the engagement leaderboard. The entire process enhances Alex's experience on the platform, fostering a sense of community and healthy competition. Other users are inspired to actively engage, creating a vibrant and interactive social media environment.

In this scenario, the platform's advanced system not only rewards Alex for their efforts but also optimizes the process through machine learning, providing a fair and dynamic reward system for influencers based on their true impact and engagement levels across various social media channels.

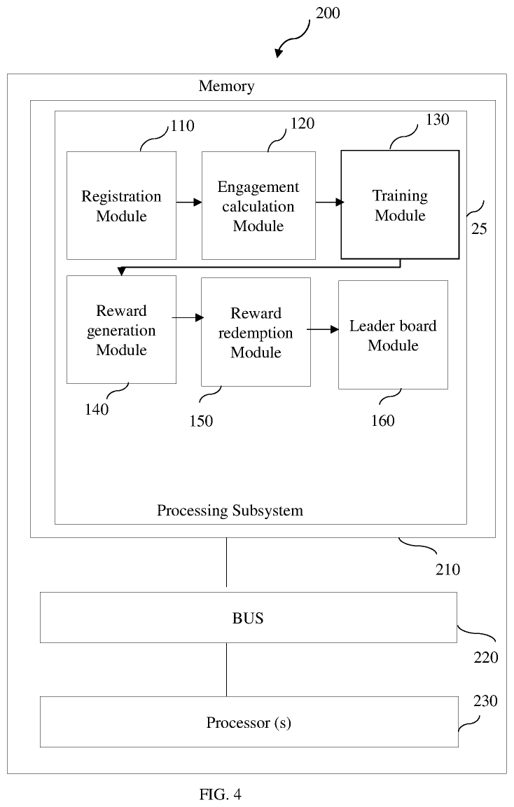

FIG. 4 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a registration module 110, an engagement calculation module 120, a training module 130, a reward generation module 140 and a reward redemption module 150.

The registration module 120 configured to register a user using one or more credentials to link corresponding plurality of social media accounts. The processing subsystem 105 also includes an engagement calculation module operatively coupled to the registration module 110, wherein the engagement calculation module 120 is configured to identify a plurality of key engagement metrics comprising likes, comments, shares, clicks, follows, mentions, and impressions for registered user on the corresponding plurality of social media accounts. The engagement calculation module 120 is also configured to calculate a plurality of individual engagement metrics corresponding to each type of engagement. The engagement calculation module 120 is further configured to calculate a total engagement value by summing up the plurality of individual engagement metrics to calculate for a specific post, content piece, or overall account. The processing subsystem 105 further includes a training module 130 operatively coupled to the engagement calculation module 120, wherein the training module 130 is configured to obtain historical dataset comprising user interactions, engagement metrics, from the social media platform. The training module 130 is also configured to train one or more machine learning models on historical dataset using a defined state representation, an action space, and a reward function. The training module 130 is further configured to fine-tune hyperparameters and optimize the reward function comprising adjusting the one or more machine learning models, learning rates, and discount factors to iterate on the training process. The processing subsystem 105 further includes a reward generation module 140 operatively coupled to the training module 130, wherein the reward generation module 140 is configured to set a conversion rate between the total engagement value and reward points. The reward generation module 140 is also configured to calculate the reward points for each user or post based on determined conversion rate. The reward generation module 140 is further configured to dynamically assign loyalty in the reward points to the user based on the engagement level using one or more trained machine learning models. The processing subsystem 105 further includes a reward redemption module 150 operatively coupled to the reward generation module 140, wherein the reward redemption module 150 is configured to create a virtual wallet for the users to accumulate the reward points. The reward redemption module 150 is also configured to convert accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

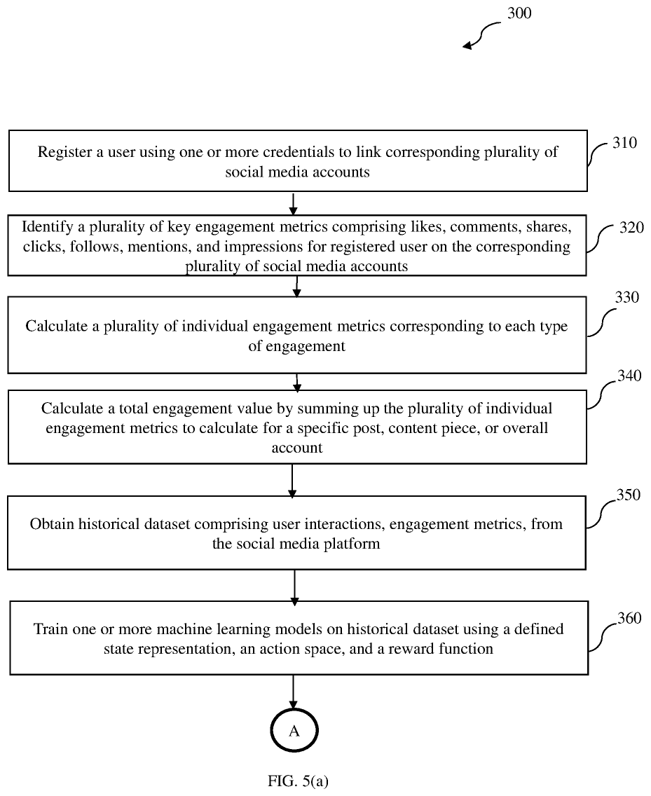

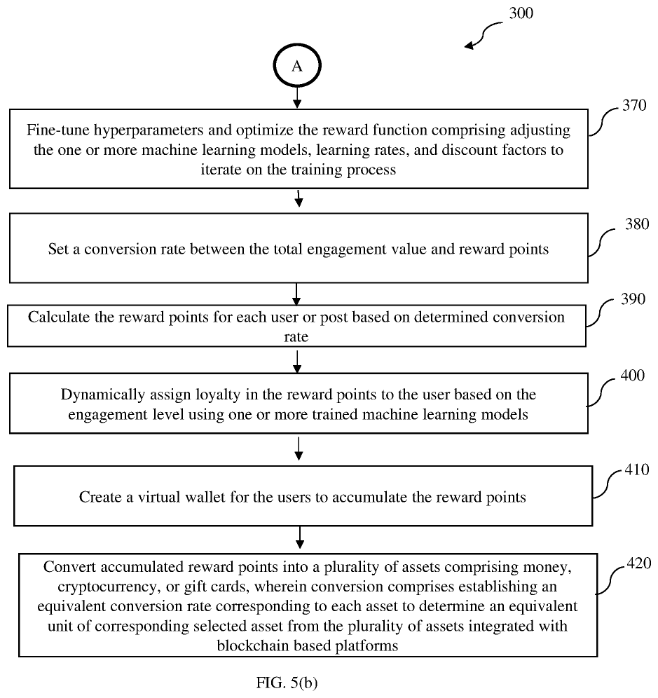

FIG. 5(a) is a flow chart representing the steps involved in a method 300 for reward generation on social media platform FIG. 1 in accordance with an embodiment of the present disclosure. FIG. 5(b) is a flow chart representing the continued steps of method for reward generation on social media platform of FIG. 5(a) in accordance with an embodiment of the present disclosure. The method 300 includes registering, by a registration module, a user using one or more credentials to link corresponding plurality of social media accounts in step 310. In one embodiment, the one or more credentials may include email and phone number. In some embodiments, receiving current location from the user to set a user profile by the registration module. The current location may be provided through global positioning system (GPS). In a specific embodiment, generating verification mark on the user profile upon setting the user profile by the registration module. For example, meeting the eligibility criteria and maintaining a positive and authentic online presence significantly increases the likelihood of successfully obtaining a verification mark. In a preferred embodiment, receiving selection of a request list from the user by the registration module, wherein the request list may include pay me followers, reward me followers or favor me followers.

The method 300 also includes identifying, by an engagement calculation module, a plurality of key engagement metrics comprising likes, comments, shares, clicks, follows, mentions, and impressions for registered user on the corresponding plurality of social media accounts in step 320. The method 300 further includes calculating, by the engagement calculation module, a plurality of individual engagement metrics corresponding to each type of engagement in step 330. The method 300 further includes calculating, by the engagement calculation module, a total engagement value by summing up the plurality of individual engagement metrics to calculate for a specific post, content piece, or overall account in step 340. In one embodiment, calculating the plurality of individual engagement metrics by counting number of likes on a post, number of comments made on a post, the number of times a post is shared, number of clicks on links or multimedia content and number of new followers gained. In some embodiment, comparing engagement across different posts or the plurality of social media accounts for normalizing the plurality of key engagement metrics, wherein normalizing the plurality of key engagement metrics may include calculating an engagement rate as a percentage of total audience or reach. In such an embodiment, determining average engagement metrics over a predefined period to identify trends and patterns in engagement.

Furthermore, the method 300 includes obtaining, by a training module, historical dataset comprising user interactions, engagement metrics, from the social media platform in step 350. The method 300 further includes training, by the training module, one or more machine learning models on historical dataset using a defined state representation, an action space, and a reward function in step 360. The method 300 further includes fine-tuning, by the training module, hyperparameters and optimize the reward function comprising adjusting the one or more machine learning models, learning rates, and discount factors to iterate on the training process in 370. In one embodiment, the defined state representation may include features and variables of current state of the social media platform, wherein the current state comprises user activity, post content, time of day and contextual information. In some embodiment, the action space may include promoting specific content, suggesting friend connections or recommending engagement strategies.

In one embodiment, the one or more machine learning models may include deep reinforcement learning models comprising deep Q-networks (DQN), policy gradient methods, and actor-critic models. In such an embodiment, simulating the one or more trained machine learning models in a controlled environment to evaluate performance, wherein the performance includes understanding of how the one or more trained machine learning model's actions impact user engagement and other metrics.

The method 300 further includes setting, by a reward generation module, a conversion rate between the total engagement value and reward points in steps 380. The method 300 further includes calculating, by the reward generation module, the reward points for each user or post based on determined conversion rate 390. The method 300 further includes dynamically assigning, by the reward generation module, loyalty in the reward points to the user based on the engagement level using one or more trained machine learning models in step 400. The method 300 further includes creating, by a reward redemption module, a virtual wallet for the users to accumulate the reward points in step 410. The method 300 further includes converting, by the reward redemption module, accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms in step 420.

In one embodiment, sending a conversion request to trigger a fund transfer request to external financial platforms or blockchain networks. In some embodiments, the method may include displaying, by a leader board module, a list of leaders based on ranking of the users based on number of reward points or badges earned. In such an embodiment, the method may include displaying the leader board based on popularity of users based on ranking engagement with followers.

Various embodiments of the present disclosure provide a system for reward generation on social media platform described above enables the use of machine learning models ensures that influencers are recognized based on their true impact and engagement levels. This creates a fair and dynamic system that accurately reflects user influence. The system considers a wide range of engagement metrics, including likes, comments, shares, clicks, follows, mentions, and impressions. This comprehensive approach provides a holistic view of an influencer's performance. By calculating total engagement values and training machine learning models, the platform can perform both real-time and historical analyses. This allows influencers and the platform to track progress and identify trends over time.

The dynamic assignment of loyalty in reward points through machine learning models ensures that influencers receive personalized rewards based on their specific engagement patterns. This adds a layer of personalization to the reward system. Influencers are motivated to produce high-quality content that resonates with their audience, as engagement directly translates into tangible rewards. This incentivizes influencers to create meaningful and engaging content.

Integration with blockchain technology ensures the security and transparency of the reward system. Transactions related to reward points and asset conversion are recorded on the blockchain, providing an immutable and verifiable record. Influencers have the flexibility to convert their accumulated reward points into various assets, including money, cryptocurrency, or gift cards. This flexibility caters to the diverse preferences and needs of influencers.

The inclusion of leaderboards and additional incentives fosters a sense of gamification and healthy competition among influencers. This contributes to a vibrant and engaging social media community. The creation of a virtual wallet simplifies the process of accumulating and managing reward points. Users can easily track their earnings and make informed decisions about asset conversion.

The training module's ability to fine-tune hyperparameters and optimize the reward function through machine learning allows the platform to continually improve and adapt to changing user behaviors and engagement patterns. The entire reward system, with its personalized rewards, blockchain security, and gamification elements, encourages influencers to maintain long-term engagement with the platform. This benefits both influencers and the platform's overall ecosystem.

In summary, the advantages of the described reward system contribute to a more engaging, fair, and secure social media environment, fostering positive interactions and sustainable growth for both influencers and the platform.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A computer implemented system for reward generation on social media platform comprising:
a hardware processor; and
a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules comprising:
a registration module configured to register a user using one or more credentials to link corresponding plurality of social media accounts;
an engagement calculation module operatively coupled to the registration module, wherein the engagement calculation module is configured to:
identify a plurality of key engagement metrics comprising likes, comments, shares, clicks, follows, mentions, and impressions for registered user on the corresponding plurality of social media accounts;
calculate a plurality of individual engagement metrics corresponding to each type of engagement;
calculate a total engagement value by summing up the plurality of individual engagement metrics to calculate for a specific post, content piece, or overall account;
a training module operatively coupled to the engagement calculation module, wherein the training module is configured to:
obtain historical dataset comprising user interactions, engagement metrics, from the social media platform;
train one or more machine learning models on historical dataset using a defined state representation, an action space, and a reward function;
fine-tune hyperparameters and optimize the reward function comprising adjusting the one or more machine learning models, learning rates, and discount factors to iterate on the training process;
a reward generation module operatively coupled to the training module, wherein the reward generation module is configured to:
set a conversion rate between the total engagement value and reward points;
calculate the reward points for each user or post based on determined conversion rate;
dynamically assign loyalty in the reward points to the user based on the engagement level using one or more trained machine learning models;
a reward redemption module operatively coupled to the reward generation module, wherein the reward redemption module is configured to:
create a virtual wallet for the users to accumulate the reward points; and
convert accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms.

2. The system of claim 1, wherein the one or more credentials comprises email and phone number.

3. The system of claim 1, wherein the registration module is configured to receive current location from the user to set a user profile.

4. The system of claim 1, wherein the registration module is configured to generate verification mark on the user profile upon setting the user profile.

5. The system of claim 1, wherein the registration module is configured to receive selection of a request list from the user, wherein the request list comprises pay me followers, reward me followers or favor me followers.

6. The system of claim 1, wherein the registration module is configured to enable the user to initiate live chat, drop and feed to create post on the corresponding plurality of social media accounts.

7. The system of claim 1, wherein the defined state representation comprises features and variables of current state of the social media platform, wherein the current state comprises user activity, post content, time of day and contextual information.

8. The system of claim 1, wherein the action space comprises promoting specific content, suggesting friend connections or recommending engagement strategies.

9. The system of claim 1, wherein the one or more machine learning models comprises deep reinforcement learning models comprising deep Q-networks (DQN), policy gradient methods, and actor-critic models.

10. The system of claim 1, wherein the training module is configured to simulate the one or more trained machine learning models in a controlled environment to evaluate performance, wherein the performance includes understanding of how the one or more trained machine learning model's actions impact user engagement and other metrics.

11. The system of claim 1, wherein the plurality of individual engagement metrics are calculated by counting number of likes on a post, number of comments made on a post, the number of times a post is shared, number of clicks on links or multimedia content and number of new followers gained.

12. The system of claim 1, wherein the engagement calculation module is configured to compare engagement across different posts or the plurality of social media accounts for normalizing the plurality of key engagement metrics, wherein normalizing the plurality of key engagement metrics comprises calculating an engagement rate as a percentage of total audience or reach.

13. The system of claim 1, wherein the engagement calculation module is configured to determine average engagement metrics over a predefined period to identify trends and patterns in engagement.

14. The system of claim 1, wherein the reward redemption module is configured to send a conversion request to trigger a fund transfer request to external financial platforms or blockchain networks.

15. The system of claim 1, wherein the processing subsystem comprises a leader board module configured to display a list of leaders based on ranking of the users based on number of reward points or badges earned.

16. The system of claim 15, the leader board module is configured to display the leader board based on popularity of users based on ranking engagement with followers.

17. A method comprising:
registering, by a registration module, a user using one or more credentials to link corresponding plurality of social media accounts;
identifying, by an engagement calculation module, a plurality of key engagement metrics comprising likes, comments, shares, clicks, follows, mentions, and impressions for registered user on the corresponding plurality of social media accounts;
calculating, by the engagement calculation module, a plurality of individual engagement metrics corresponding to each type of engagement;
calculating, by the engagement calculation module, a total engagement value by summing up the plurality of individual engagement metrics to calculate for a specific post, content piece, or overall account;
obtaining, by a training module, historical dataset comprising user interactions, engagement metrics, from the social media platform;
training, by the training module, one or more machine learning models on historical dataset using a defined state representation, an action space, and a reward function;
fine-tuning, by the training module, hyperparameters and optimize the reward function comprising adjusting the one or more machine learning models, learning rates, and discount factors to iterate on the training process;
setting, by a reward generation module, a conversion rate between the total engagement value and reward points;
calculating, by the reward generation module, the reward points for each user or post based on determined conversion rate;
dynamically assigning, by the reward generation module, loyalty in the reward points to the user based on the engagement level using one or more trained machine learning models;
creating, by a reward redemption module, a virtual wallet for the users to accumulate the reward points; and
converting, by the reward redemption module, accumulated reward points into a plurality of assets comprising money, cryptocurrency, or gift cards, wherein conversion comprises establishing an equivalent conversion rate corresponding to each asset to determine an equivalent unit of corresponding selected asset from the plurality of assets integrated with blockchain based platforms.
